(19) United States
(12) Patent Application Publication
(10) Pub. No.: US 2008/0177919 A1
(43) Pub. Date: Jul. 24, 2008

(54) Communication system and method for assigning addresses

(75) Inventor: Kazuhiro Miyazawa, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/896,333

(22) Filed: Aug. 31, 2007

(30) Foreign Application Priority Data
Sep. 7, 2006 (JP) JP 2006-243033

(51) Int. Cl. G06F 13/18

(52) U.S. Cl. 710/110

(57) ABSTRACT

A master ECU instructs door actuators having a counter value of θ n (where n=1,2,3) to set the address n as their unique network addresses. A control unit in each door servo actuator determines whether a counter value (θ n) that is the subject of a query from the master ECU corresponds to its own counter value, and the control unit sets the address n, when the control unit determines that the counter value (θ n) of the query corresponds to its own counter value. The counter value (θ n) is a unique quantity associated with each servo actuator

### CROSS REFERENCE TO RELATED APPLICATION

This application is based on Japanese Patent Application No. 2006-243033 filed on Sep. 7, 2006, the disclosure of which is incorporated herein by reference.

### FIELD OF THE INVENTION

The present invention relates to communication system and method for assigning addresses of a plurality of slave units in communication system communicating between a master unit and a plurality of slave units.

### BACKGROUND OF THE INVENTION

For example, a known communication system is described in JP-A-H09-116565, which shows a connection known as a daisy chain. This connection has a bus line extending from a master unit to an upstream slave unit. The bus line further extends sequentially from the upstream slave unit to downstream slave units.

Also, in the apparatus of JP-A-H09-116565, the bus line from the master unit is connected to the upstream slave unit (the slave unit closest to the master unit). Each slave unit is able to communicate with the master unit through the bus line and through a switch installed inside of the slave unit.

When each slave unit communicates with the master unit, each slave unit closes its switch, and a signal on the bus line is transmitted to each downstream slave unit.

On the other hand, the assignment of an address to each slave unit is done as follows. At first only the most upstream slave unit can communicate with the master unit by opening its switch. A predetermined address is assigned to the most upstream slave unit by communicating with the master unit. Then, the most upstream slave unit closes its switch. Consequently, the next downstream slave unit can communicate with the master unit by opening its switch. After that slave unit is assigned an address by communicating with the master unit, it closes its switch.

By moving sequentially from the most upstream slave unit to the downstream units, all the slave units are assigned addresses.

In such a conventional system, two problems exist. One is that each slave unit communicates with the master unit through the daisy chain connection. Consequently, two connectors are necessary for the bus line to enter and exit each slave unit, and wiring is complicated.

Secondly, an address is assigned from the most upstream slave unit to the downstream slave units sequentially. When a mistake occurs in the connection position of a slave unit, the slave unit that is in the wrong connection position is assigned an address that is different from the address that should be assigned, and the master unit is not able to communicate with each slave unit normally.

### SUMMARY OF THE INVENTION

In view of the above-described problems, it is an object to provide a communication system and a method of address assignment in which a correct address can be assigned to each slave unit regardless of its connection position on the network line, and the wiring for the connection to the network line from each slave unit is simplified. In accordance with an aspect of the present invention, a communication system includes a plurality of slave units respectively associated with a unique quantity, a master unit communicating with the slave units, and a network line connected to the plurality of slave units and to the master unit. Each slave unit has a unique quantity. The master unit issues a query to the slave units. The query seeks to determine whether a predetermined value corresponds with the unique quantity of the slave units. Each slave unit sets a unique address based on an instruction of the master unit when the predetermined value of the query corresponds to the unique quantity associated with each slave unit.

Each query from the master unit is simultaneously sent to all slave units connected to a network line. Each slave unit sets the unique address based on the instruction of the master unit when the predetermined value of the query corresponds to the unique quantity associated with each slave unit. Consequently, the master unit can sequentially assign the unique address to each slave unit by sequentially issuing the queries.

In other words, because the master unit assigns the unique address to only the slave unit having the unique quantity that corresponds to the predetermined value, the master unit can assign a correct unique address to each slave unit regardless of the connecting position between the master unit and the slave units.

Preferably, the network line is formed in the shape of a loop. Therefore, even if the network line is cut by some kind of malfunction, all slave units can communicate with master unit, which improves reliability.

Preferably, the slave units respectively control a plurality of door servo actuators for adjusting an open degree of several kinds of doors in a vehicle air conditioning system. The unique quantity is a maximum operation degree of each door servo actuator.

Even if the actuators have the same function, the unique quantities are different in view of the individual function. Regarding the door servo actuators, the maximum operation degrees of the door servo actuators necessary to open and close the doors are different, and the maximum operation degree is the unique quantity. Therefore, addresses can be individually assigned to each slave unit even if the function of the actuators controlled by slave units is the same.

In an alternative embodiment, the slave units respectively control a plurality of door servo actuators for adjusting an open degree of several kinds of doors in a vehicle air conditioning system, and the unique quantity is a current value of the supplied driving current when each door servo actuator is operated.

Regarding the door servo actuators, the current value of the door servo actuators necessary to open and close the doors are different, and the current value is the unique quantity. Therefore, addresses can be individually assigned to each slave unit even if the function of the actuators controlled by slave units is the same.

Preferably, the master unit transmits an operation instruction for all of the plurality of slave units to operate the door servo actuators from the base position to the maximum operation degree position before the query is issued. Each slave unit determines the maximum operation degree by operating the door servo actuator controlled by the slave unit, when each slave unit receives an instruction from the master unit.

Therefore, each slave unit can certainly determine its own unique quantity unit when an address is assigned.

Preferably, each slave unit includes a unique quantity memory to store the unique quantity.

Therefore, once the maximum operation degree is determined and is stored by operating the door from the base position to the maximum operation degree position, the operation determining the unique quantity need not be repeated, which shortens the time required to assign the unique addresses.

Preferably, the slave unit comprises an address memory to store the set address.

Therefore, because the address memory stores the assigned address, it is not necessary to re-assign the address whenever the communication system re-boots.

Preferably, the network communication in the system takes place only on the network line, which is a single line.

Because each slave unit connects to the single network line, each slave unit needs just one connector to connect to the network line. Thus, wiring to connect each slave unit to the network line can be simplified.

In accordance with another aspect of the present invention, a method for assigning an address includes issuing a query to a plurality of slave units and setting an address in the one slave unit based on an instruction of the master unit when a value that is the subject of a query corresponds to a unique quantity associated with the one slave unit. The master unit assigns a unique address to the one slave unit that has a unique quantity corresponding to the value. The query seeks one slave unit that is associated with one of a plurality of predetermined unique quantities. Each slave unit has a unique quantity.

Preferably, the slave units respectively control a plurality of door servo actuators for adjusting an open degree of several kinds of doors of a vehicle air conditioning system. The unique quantity is a maximum operation degree of each door servo actuator. And, the method further includes transmitting an operation instruction from the master unit to all of the slave units to operate the door servo actuators from a base position to a maximum operation degree position before the query is issued. The maximum operation degree in each slave unit is determined by operating the door servo actuator controlled by the slave unit, when the slave unit receives an operation instruction from the master unit.

In accordance with another aspect of the present invention, A method of setting unique network addresses in a network includes a master controller and a plurality of slave units. The master controller communicates to each slave unit through network communication. Each slave unit has a unique quantity. The method includes determining in each slave unit a unique quantity by performing an operation and measuring a result of the operation, storing in each slave unit the unique quantity and assigning a unique network address to each slave unit in correspondence with the unique quantity stored in each slave unit.

Preferably, the slave units are connected to a network line that leads to the master controler.

Preferably, the method includes storing the network address in non-volatile memory in each slave unit.

Preferably, the slave units are servo-motor actuators and the operation is an operation of the servo-motor in a predetermined routine.

Preferably, the method includes installing the network in a vehicle such that each slave unit serves to actuate a different door in a vehicle air-conditioning system.

Preferably, the method includes storing data in the master controller that represents a correspondence between a plurality of unique quantities and unique network addresses.

### BRIEF DESCRIPTION OF THE DRAWINGS

Other objects, features and advantages of the present invention will become more apparent from the following detailed description made with reference to the accompanying drawings, in which:

FIG. 1 is a schematic diagram showing the overall configuration of the air conditioning system according to the first embodiment of the present invention;

FIG. 2 is a block diagram showing the configuration of a local network in an air conditioning system;

FIG. 3 is a perspective diagram showing a connection to the network line of a connector fitted to each door servo actuator;

FIG. 4 is the block diagram showing the inside configuration of each door servo actuator;

FIG. 5 is a flow chart showing a control method of the master ECU according to the first embodiment of the present invention;

FIG. 6 is a flow chart showing a process of setting a counter value of each door servo actuator according to the first embodiment of the present invention;

FIG. 7 is a flow chart showing a process of setting an address of each door servo actuator according to the first embodiment of the present invention;

FIG. 8 is a table showing a classification of door servo actuators, counter value and address corresponding to the classification of the door servo actuators;

FIG. 9 is a block diagram showing a loop shaped bus connection according to an air conditioning system of the second embodiment of the present invention;

FIG. 10 is a flow chart showing a control method of the master ECU according to the third embodiment of the present invention;

FIG. 11 is a flow chart showing a process of setting an address of each door servo actuator according to the third embodiment of the present invention;

FIG. 12 is a table showing a classification of door servo actuators, current value and address corresponding to the classification of the door servo actuators according to the third embodiment of the present invention; and

FIG. 13 is a perspective diagram showing the connection to the network line of connectors fitted to each door servo actuator according to another embodiment of the present invention.

### DETAILED DESCRIPTION OF THE PREFERRED EMBODIMENTS

The preferred embodiments of the present invention will be explained with reference to the accompanying drawings. In the drawing, the same numerals are used for the same components and devices.

### FIRST EMBODIMENT

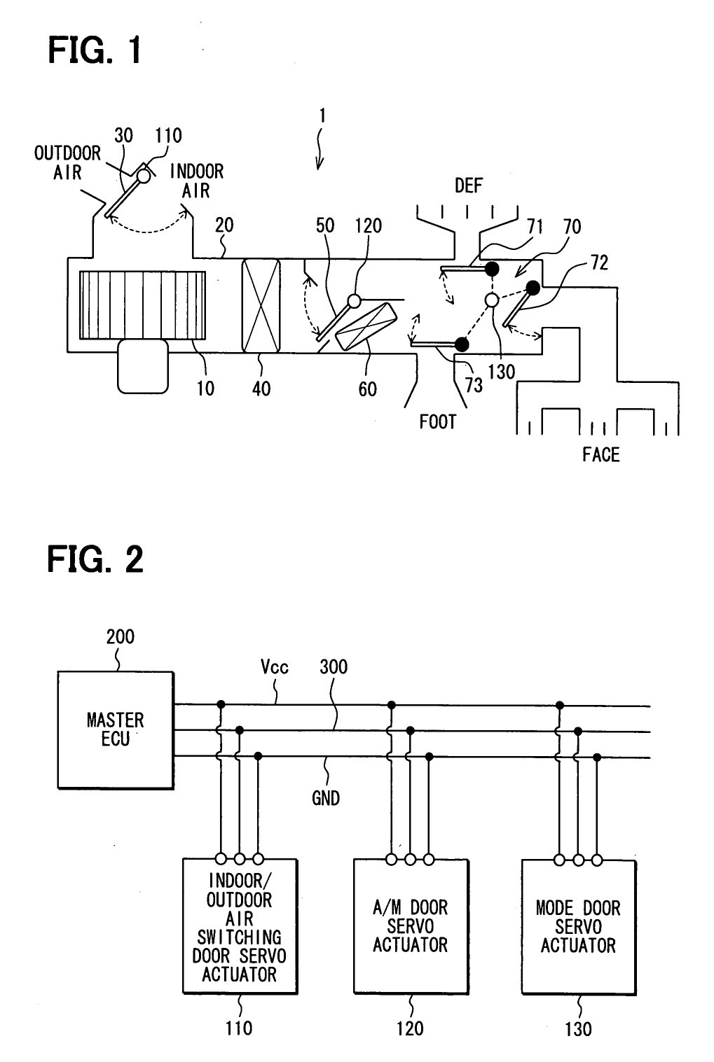

A first preferred embodiment of the present invention applied to an air conditioning system for vehicle will be described with reference to FIGS. 1-8. FIG. 1 shows the overall configuration of the air conditioning system 1. The air conditioning system 1 selects air entering an air conditioning case 20 from a blower fan 10 with an indoor/outdoor air switching door 30. The air conditioning system 1 cools the introduced air by a cooling heat exchanger 40. The open degree control of an air mixing door 50 adjusts a distribution ratio between the air leading to a heating heat exchanger 60 and the air bypassing the heat exchanger 60 in the air that has passed the cooling heat exchanger 40. After this, the air conditioning system 1 makes conditioned air by mixing air that passes through and air that bypasses the heating heat exchanger 60. Finally the air conditioning system 1 controls the open degree pattern of mode doors 70 (71,72,73), which open or close each outlet, and adjusts the ratio of wind quantity of the conditioned air exiting each outlet.

Among the components of this air conditioning system 1, the indoor/outdoor air switching door 30, the air mixing door 50 and the mode door 70 ( are rotationally driven by door servo actuators 110,120,130 respectively. An indoor/outdoor air switching door servo actuator 110 selectively opens an indoor air introducing port or an outdoor air introducing port with the indoor/outdoor air switching door 30. An A/M door servo actuator 120 adjusts a distribution ratio between the air passing through the heating heat exchanger 60 and the air bypassing the heating heat exchanger 60 by rotationally driving the air mixing door 50 to a predetermined open degree. A mode door servo actuator 130 adjusts the ratio of wind quantity of the conditioned air exiting each outlet by changing the open degree of each mode door 71,72,73 with a link structure.

As shown in FIG. 2, each door servo actuator 110,120,130 obeys instructions from a master ECU 200 (a master unit) that controls each component in the air conditioning system 1. Each door servo actuator 110,120,130 rotationally drives the corresponding door 30,50,70. A local network is built into the air conditioning system 1. The master ECU 200, each door servo actuator 110,120,130, and other control units (not shown) are connected by the local network. Communication is performed using the well-known LIN (Local Interconnect Network) bus system. The master ECU 200 individually assigns addresses to each door servo actuator 110,120,130 to identify the actuators.

The master ECU 200 is connected to the one end of a LIN bus line 300. Each door servo actuator 110,120,130 is connected to the LIN bus line 300. The master ECU 200 and each door servo actuator 110,120,130 are respectively connected to a power line Vcc and a ground line GND. The termination of the LIN bus line 300 is opened.

Pressure fitting connectors 110A, 120A, 130A are fitted in each door servo actuator 110,120,130. These connectors 110A, 120A, 130A are connected to the LIN bus line 300, the power line Vcc and the ground line GND. Thus, each door servo actuator 110,120,130 is connected to the LIN bus line 300, the power line Vcc and the ground line GND in a common manner.

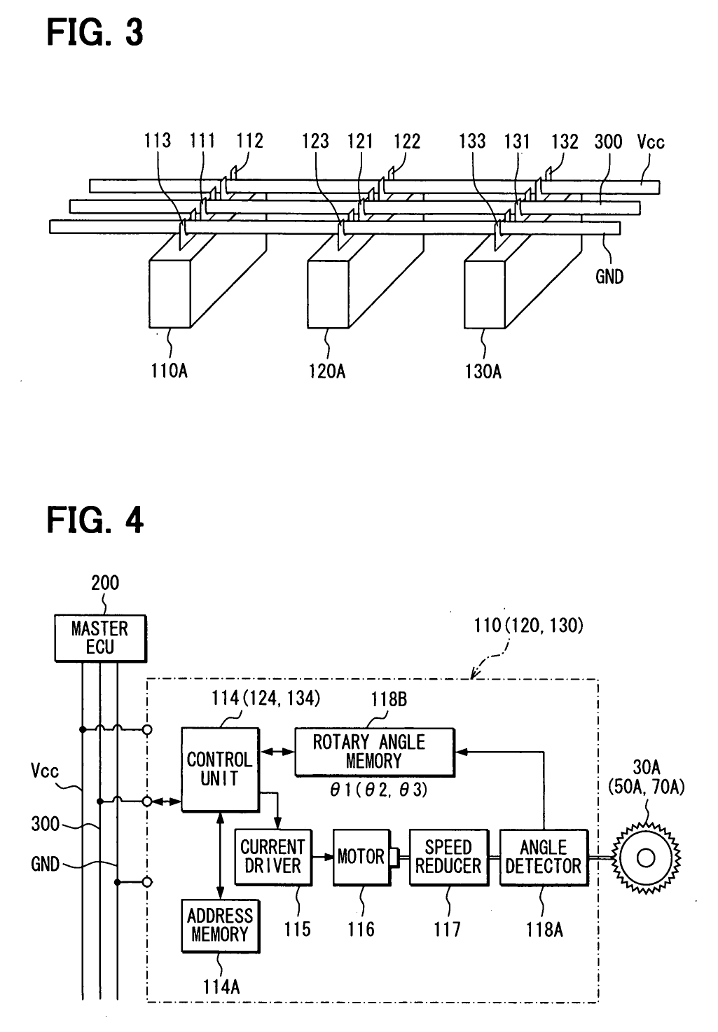

The manner in which connectors 110A, 120A, 130A, which are fitted in each door servo actuator 110,120,130, connect to the LIN bus line 300 is shown in FIG. 3. Pressure fitting terminals 111,121,131 that are used to form electrical connections are installed in each connector 110A, 120A, 130A. Each pressure fitting terminal 111,121,131 connects to the LIN bus line 300. Specifically, the coating of the cable of the LIN bus line 300 is cut by press fitting the LIN bus line 300 in the terminal recess portion of the pressure fitting terminal 111,121,131. Then, an inside conductor of the LIN bus line 300 is inserted within the terminal recess portion and makes electrical contact. As a result, each door servo actuator 110,120,130 is connected to the LIN bus line 300. Also, pressure fitting terminals 112,122,132 and pressure fitting terminals 113,123,133 are installed on each connector 110A,120A,130A. The pressure fitting terminals 112,122,132 connect to the power line Vcc. The pressure fitting terminals 113,123,133 connect to ground line GND. The power line Vcc and the ground line GND are connected to the pressure fitting terminals 112,113,122,123,132,133 by same connection method described above concerning the pressure fitting terminal 111,121,131 and the LIN bus line 300.

The inner configuration of each door servo actuator 110,120,130 is shown in FIG. 4. The inner configuration of each door servo actuator 110,120,130 is the same. Part names in the indoor/outdoor air switching door servo actuator 110 are shown in FIG. 4. Part names for the A/M door servo actuator 120 and the mode door servo actuator 130 are given in the figures if necessary.

A control unit 114 (a slave unit) communicates with the master ECU 200. The control unit 114 includes a semiconductor integrated circuit and predetermined software. The control unit 114 provides the function of a transceiver to perform LIN communication. A motor 116 is installed in the door servo actuator 110. The control unit 114 controls the motor 116 according to instructions from the master ECU 200 based on the desired open degree of the indoor/outdoor air switching door 30 to set the open degree of the indoor/outdoor air switching door 30.

An address memory 114A stores an address assigned to the actuator in which it is installed by an address assignment described below. The address memory 114A includes non-volatile memory that can store information even when the power supply is interrupted.

A current driver 115 supplies driving current for the motor 116 by control signals from the control unit 114. The motor 116 receives driving current supplied from the current driver 115 and rotates accordingly. The rotation of the motor axle is transmitted to a gear 30A installed in the pivot rod of the door 30 through a speed reducer 117.

An angle detector 118A detects the rotary angle (open degree of the door 30) of the output stage of the speed reducer 117. The angle detector 118A includes, for example, an incremental rotary encoder. The angle detector 118A outputs pulsed signals depending on the detected rotary angle to a rotary angle memory 118B (The rotary angle memory 118B may also be referred to herein as a unique quantity memory). The rotary angle memory 118B stores a counter value that represents the rotary angle from a base position (described below) of the door 30. Specifically, the rotary angle memory 118B stores a counter value as the open degree, or position, of indoor/outdoor air switching door 30 by adding the input number of the pulsed signal to the counter value or by subtracting the input number of the pulsed signal from the counter value. The rotary angle memory 118B outputs the counter value in the control unit 114 in response to a demand from the control unit 114.

The A/M door servo actuator 120 and the mode door servo actuator 130 are similar to the indoor/outdoor air switching door servo actuator 110, and the difference is explained below. Regarding the A/M door servo actuator 120, a control unit 124 (a slave unit) controls a motor 116 within the door servo actuator 120 according to instruction from the master ECU 200 based on the desired open degree of the air mixing door 50. The rotation of the motor 116 is transmitted to a gear 50A installed in the pivot rod of the air mixing door 50 through a speed reducer 117. An angle detector 118A detects the rotary angle (open degree of the door 50) of the output stage of the speed reducer 117, and a rotary angle memory 118B stores a counter value that represents the open degree, or position, of the door 50.

Regarding the mode door servo actuator 130, the control unit 134 (a slave unit) controls the motor 116 in the door servo actuator 130 according to instructions from the master ECU 200 based on the desired open degree of the mode door 70 to adjust the open degree of the mode door 70. The rotation of the motor 116 is transmitted to a gear 70A installed in the link structure through a speed reducer 117. An angle detector 118A detects the rotary angle (open degree of the gear 70A) of the output stage of the speed reducer 117, a rotary angle memory 118B stores a counter value that represents the rotary degree, or position, of the gear 70A of the link structure.

The following is an explanation of the operation of the apparatus described above. The master ECU 200 controls each door servo actuator 110,120,130 and other control units to accomplish the desired air conditioning state. Specifically, the master ECU 200 respectively instructs each door servo actuator 110,120,130 to set the open degree of the corresponding door 30,50,70, based on the set temperature in the passenger compartment. Each door servo actuator 110,120,130 sets the position of the corresponding door 30,50,70, to a predetermined open degree by rotationally driving the motor 116 in accordance with the instructions. Each door servo actuator 110,120,130 is assigned an address “1”, “2”, “3,” respectively, for example. The master ECU 200 recognizes each door servo actuator 110,120,130 individually by the address “1”, “2”, “3” respectively assigned to each door servo actuator 110,120,130.

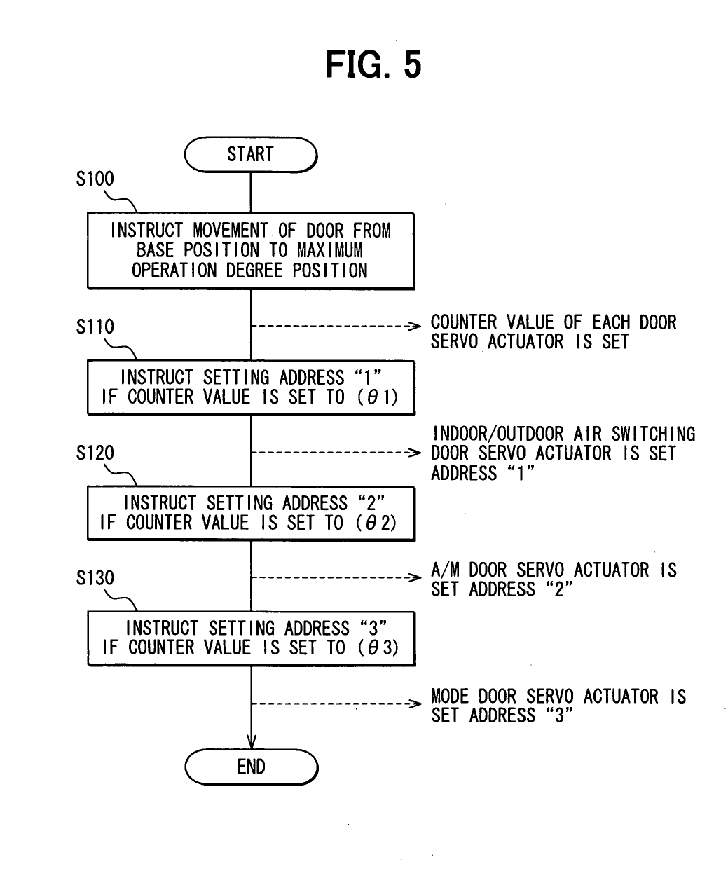

The method of the address assignment to each door servo actuator 110,120,130 is explained referring to FIGS. 5-8 as follows. Unless otherwise specified, the following description applies generally to FIG. 5.

The master ECU 200 instructs each door servo actuator 110,120,130 to make the corresponding door 30,50,70 operate from the base position to the maximum operation degree position (step S100).

The base position is a position of each door at which the door is restricted from moving any further in a first direction when driven in the first direction by the corresponding servo actuator. The maximum operation degree position is a position of each door at which the door is restricted from moving any further in a second direction, which is opposite to the first direction, when driven in the second direction by the corresponding servo actuator.

In this embodiment, the base position of the doors 30,50 is a closed position of the doors 30,50 at which the doors 30,50 cannot pivot further when driven in the first direction by the corresponding door servo actuator 110,120. The maximum operation degree position of the doors 30,50 is a closed position of the doors 30,50 at which the doors 30, 50 are restricted from pivoting any further when driven in the second direction by the corresponding door servo actuator 110,120.

The base position of the mode doors 70, in this embodiment, is a position of the doors 71 ,72,73 at which the doors 71, 72, 73 are restricted from further movement when driven in a first direction by the servo actuator 130. The maximum operation degree position of the mode doors 70 is a position of the doors 71,72,73 at which the doors 71, 72, 73 are restricted from further movement when driven in a second direction by the servo actuator 130.

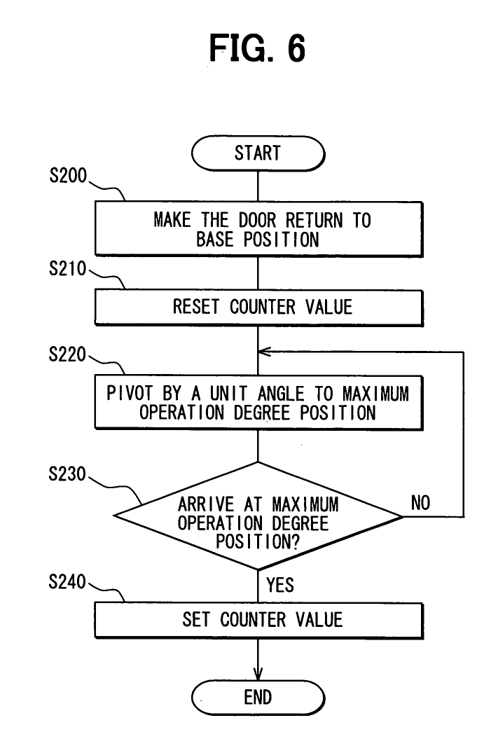

The control unit 114,124,134 of each door servo actuator 110,120,130, which receives the operating instruction, rotationally drives the motor 116 to make the door 30,50,70 return to the base position (step S200) as shown in FIG. 6,. The control unit 114,124,134 resets the counter value stored in the rotary angle memory 118B when the door 30,50,70 returns to the base position (step S210). Then, the control unit 114,124,134 pivots the door 30,50,70 by a unit angle to the maximum operation degree position by driving the motor 116 (step S220). When the control unit 114,124,134 rotationally drives the motor 116, the rotary angle memory 118B adds, or counts, pulsed signals from the angle detector 118A, and the rotary angle memory 118B stores the counter value after the addition. When the control unit 114,124,134 determines that the corresponding door 30,50,70 has arrived at the maximum operation degree position (when the result of step S230 is positive), the control unit 114,124,134 sets the counter value (a maximum operation degree counter value) at that time in the rotary angle memory 118B (step S240).

Thus, a counter value θ 1 is set in the indoor/outdoor air switching door servo actuator 110 as representing the maximum operation degree of the door 30. A counter value θ 2 is set in the A/M door servo actuator 120 as representing the maximum operation degree of the door 50. A counter value θ 3 is set in the mode door servo actuator 130 as representing the maximum operation degree of the mode doors 70. Thus, the counter values θ 1, θ 2, θ 3 of the door servo actuators 110,120,130 are designed to be different from one another, or unique. Each counter value θ 1, θ 2, θ 3 is a unique quantity of the invention.

The master ECU 200 stores the counter value of each door servo actuator 110,120,130, and has determined the address “1”, “2”, “3” that should be assigned to each door servo actuator 110,120,130. In other words, the master ECU 200, as shown in FIG. 8, stores data representing the counter value corresponding to the classification of each door servo actuator 110,120,130 and the address that should set.

After a predetermined time (after a time when it seems that the counter value has been set each door servo actuator 110,120,130) has passed since the master ECU 200 instructed movement from the base position to the maximum operation degree position, the master ECU 200 instructs each door servo actuator 110,120,130 to set address “1” if the counter value is set to θ 1 (step S110).

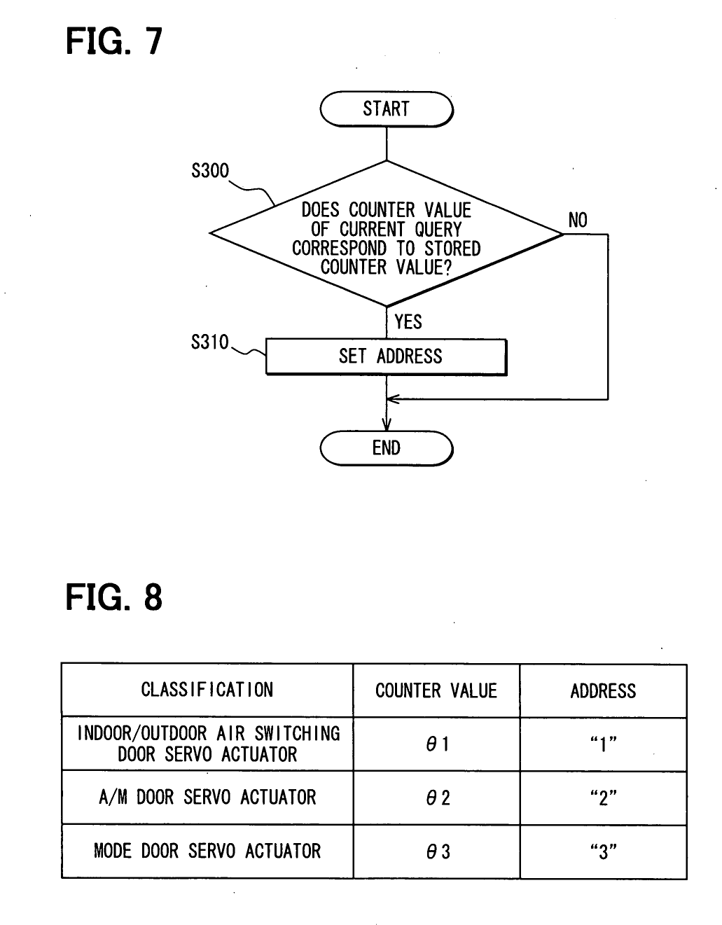

The control unit 114,124,134 of each door servo actuator 110,120,130, determines whether the counter value inquired by the master ECU 200 corresponds to the counter value stored in its own rotary angle memory 118B (step S300) as shown in FIG. 7. When the control unit 114,124,134 determines that the counter value of θ 1 exists in its own memory 118B, the control unit 114,124,134 sets its own address as the instructed address (the result of step S300 is affirmative and step S310 is performed).

Because, among the door servo actuators 110,120,130, the counter value set in the rotary angle memory 118B of the indoor/outdoor air switching door servo actuator 110 is θ 1, the control unit 114 of the door servo actuator 110 determines that its own counter value θ 1 corresponds to the inquired counter value θ 1, sets the address “1”, and stores the address in the address memory 114A.

Then, the master ECU 200 instructs each door servo actuator 110,120,130 to set address “2” if the counter value is set to θ 2 (step S120).

Because, among the door servo actuators 110,120,130 which received the instruction, the counter value set in the rotary angle memory 118B of the A/M door servo actuator 120 is θ 2, the control unit 124 of the door servo actuator 120 determines that its own counter value θ 2 corresponds to the inquired counter value θ 2, sets the address “2”, and stores the address in the address memory 114A.

Finally, in the same manner, the master ECU 200 instructs each door servo actuator 110,120,130 to set address “3” if the counter value is set to θ 3 (step S130).

Because, among the door servo actuators 110,120,130 that received the instruction, the counter value set in the rotary angle memory 118B of the mode door servo actuator 130 is θ3, the control unit 134 of the door servo actuator 130 determines that its own counter value θ 3 corresponds to the counter value θ 3 that is the subject of the current query, sets the address “3”, and stores the address in the address memory 114A.

As shown in FIG. 7, each door servo actuator 110,120,130 ignores the instructions if the counter value that is the subject of the current query is different from its own counter value when it receives the address setting instructions from the master ECU 200 (when the result of step S300 is negative).

When the above address assignment is completed, the address “1” is assigned to the indoor/outdoor air switching door servo actuator 110, the address “2” is assigned to the A/M door servo actuator 120 and the address “3” is assigned to the mode door servo actuator 130.

Thus, the master ECU 200 individually controls each door servo actuator 110,120,130 by using the addresses “1”, “2”, “3” when the master ECU 200 controls the doors 30,50,70.

After having assigned the address, the assigned address continues being stored in the address memory 114A of each door servo actuator 110,120,130. Consequently, the air conditioning system 1 does not need to perform the above address assignment routine when the system boots again after stopping the air conditioning system 1, and performs air conditioning control immediately.

According to this embodiment, the address setting instructions for the door servo actuators 110,120,130 are simultaneously sent to each door servo actuator 110,120,130 connected to the LIN bus line 300 by the master ECU 200. The door servo actuator 110,120,130 having the counter value that corresponds to the counter value that is the subject of the current query sets a predetermined address, according to the instruction of the master ECU 200. Thus, the master ECU 200 is able to assign a unique address to each door servo actuator 110,120,130 individually by sending queries regarding several different counter values sequentially.

In other words, because the address setting starts from the door servo actuator 110,120,130 whose counter value corresponds to the counter value that is the subject of the current query, the master ECU 200 is able to assign the correct address to each door servo actuator 110,120,130, regardless of its connection position on the bus.

In addition, because the connection of the master ECU 200 and each door servo actuator 110,120,130 to LIN bus line 300 is not a daisy chain connection but is of a common type that the each slave unit is electrically connected to a single network line, the pressure fitting terminals 111,121,131 to connect the LIN bus line 300 is done with one connector 110A fitted in each door servo actuator 110,120,130. Thus, the wiring to connect each door servo actuator 110,120,130 to LIN bus line 300 is simplified.

In the present embodiment, because each door servo actuator 110,120,130 includes non-volatile address memory 114A, once an address is assigned, it is not necessary to re-assign the address whenever the air conditioning system 1 re-boots. Therefore, the system 1 can be operated as soon as possible.

In the present embodiment, though each door servo actuator 110,120,130 has the same function as far as making the door 30,50,70 rotate, the counter value (the maximum operation degree) as the unique quantity is different in each actuator 110,120,130. In this embodiment, the maximum operation degree of the doors 30,50,70 controlled by the door servo actuators 110,120,130 are made to be unique, since an address is assigned by the counter value corresponding to this maximum operation degree. Thus, even if the general function of the door servo actuators 110,120,130 is the same, a unique address can be assigned each door servo actuator 110,120,130.

In the present embodiment, because the counter value is set in each door servo actuator 110,120,130 by making each door 30,50,70 rotate from the base position to the maximum operation degree position, when the address is assigned to each door servo actuator 110,120,130, the counter value can be determined with certainty even if the angle detector 118A of each door servo actuator 110,120,130 is an incremental type angle detector.

### SECOND EMBODIMENT

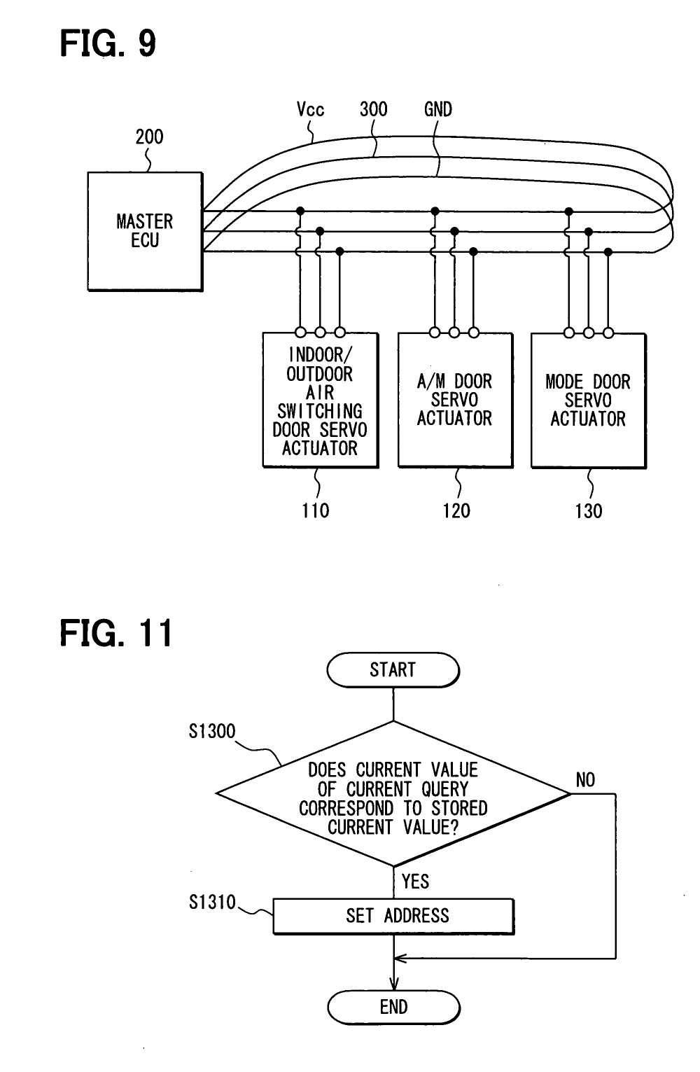

The second embodiment concerning the present invention is explained referring to FIG. 9. In this embodiment, the LIN bus line 300 forms a loop, and each door servo actuator 110,120,130 is connected to the single LIN bus line 300 in a common manner. When the LIN bus line 300 is configured as shown, even if one point on the LIN bus line 300 is cut by some kind of malfunction, each door servo actuator 110,120,130 can still communicate with the master ECU 200, and the reliability of the system 1 improves.

### THIRD EMBODIMENT

In first embodiment, the address is assigned for each door servo actuator 110,120,130 by using a counter value corresponding to the maximum operation degree as the unique quantity. But, for example, each actuator 110,120,130 may use a current value of the driving current when the current driver 115 supplies current to the motor 116 as the unique quantity.

The motor 116 usually has to be supplied with a driving current to generate torque depending on the load torque. The torque necessary to rotationally drive the doors 30,50,70 differs from one door to the other because the doors 30,50,70 are different regarding size and the forces from passing air.

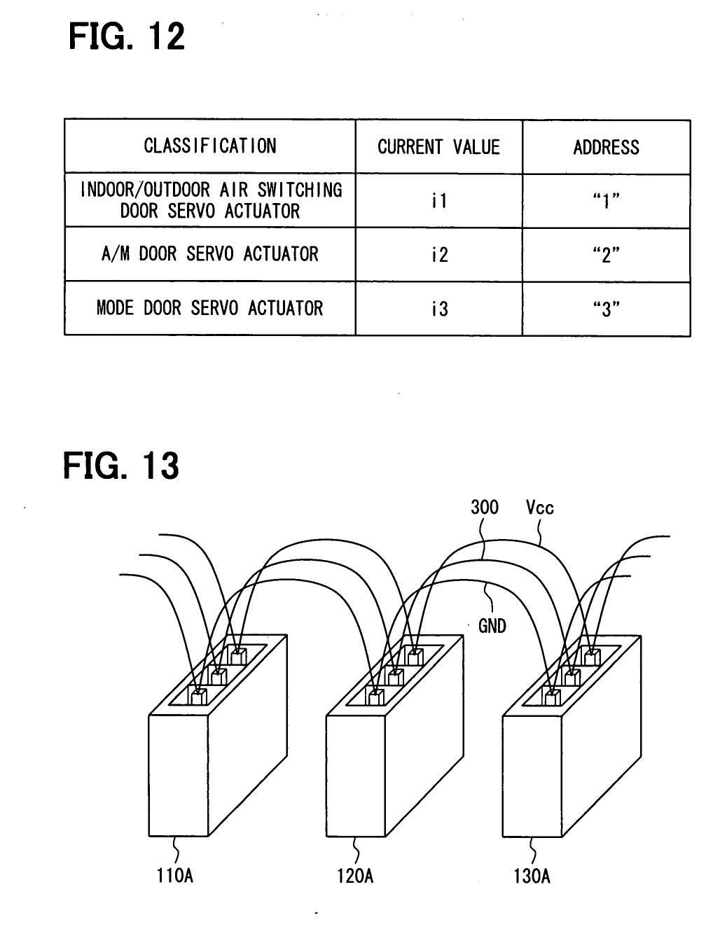

In the third embodiment, each door servo actuator 110,120,130 stores a current value of the driving current supplied from current driver 115. The master ECU 200, as shown in FIG. 12, stores the current values corresponding to the classification of each door servo actuator 110,120,130 and the corresponding addresses.

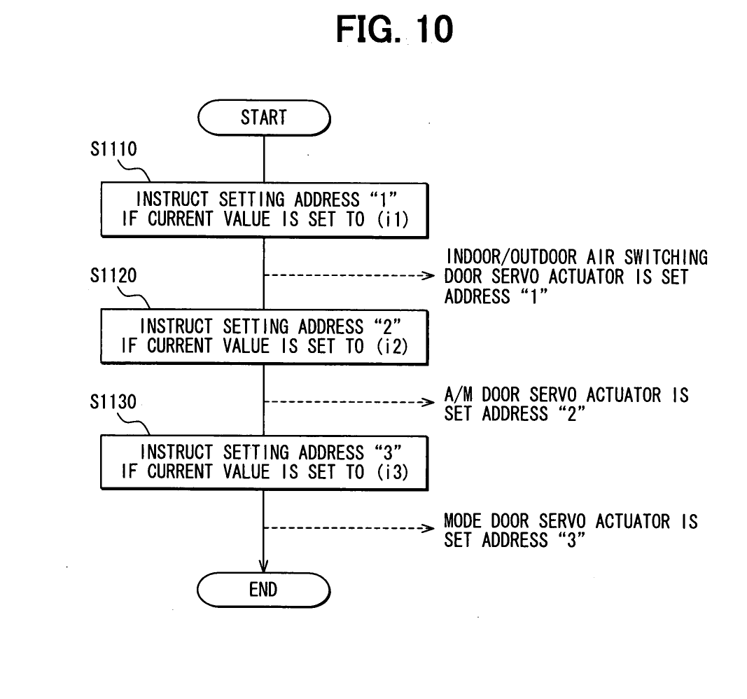

Regarding the address assignment, as shown in FIG. 10, the master ECU 200 instructs each door servo actuator 110,120,130 to set address “1” if the current value is set to (i1) (step S1110). The master ECU 200 successively instructs each door servo actuator 110,120,130 to set address “2” if the current value is set to (i2) (step S1120). Finally, the master ECU 200 instructs each door servo actuator 110,120,130 to set address “3” if the current value is set to (i3) (step S1130).

The control unit 114,124,134 of each door servo actuator 110,120,130, as shown in FIG. 11, determines whether the value that is the subject of the current query by the master ECU 200 corresponds to its own stored counter value (step S1 300). When the control unit 114,124,134 determines that the correspondence exists, the control unit 114,124,134 sets the instructed address for itself (when the result of step S1300 is affirmative and step S1310 is performed).

When the above address assignment is completed, the address “1” is assigned to the indoor/outdoor air switching door servo actuator 110, the address “2” is assigned to the A/M door servo actuator 120 and the address “3” is assigned to the mode door servo actuator 130.

The master ECU 200 assigns the addresses based on current value, therefore, the master ECU 200 can assign a unique address to each door servo actuator 110,120,130 individually.

### OTHER EMBODIMENT

Although the present invention has been fully described in connection with preferred embodiments thereof with reference to the accompanying drawings, various changes and modifications will become apparent to those skilled in the art.

For example, in above embodiments, the three door servo actuators 110,120,130 (slave units) connected on the network are assigned addresses, but the number of slave units that are given addresses may be two or more than four. In the above embodiments, the mode door servo actuator 130 rotationally drives a plurality of mode doors 71,72,73 with a link structure, but a door servo actuator may be attached to each mode door 71,72,73 individually.

In the first embodiment, an angle detector 118A is an incremental type rotary encoder (a relative position type detector); however, the absolute type of detector (an absolute position type detector) may be substituted. When a rotary encoder of the absolute type was applied, because it is not necessary to make the doors 30,50,70 return the base position to set the counter value, the time necessary for the address assignment can be shortened. Also, a potentiometer may be used as the angle detector 118A.

In the first embodiment, the connector fitted to each door servo actuator 110,120,130 is providing the pressure fitting terminal 111,121,131, but for example, as shown in FIG. 13, a crimping connector may be used instead of a pressure fitting connector 110A,120A,130A. In this case, a plurality of connection ends installed in a cable, for example the LIN bus line 300, connect to the crimping terminal of the crimping connector respectively.

In the first embodiment, the control unit 114,124,134 is made by incorporating software having the above described function in a semiconductor integrated circuit, but the control units 114,124,134 may be made by employing hardware logic.

In the first embodiment, the master ECU 200 and each door servo actuator 110,120,130 communicate according to the LIN protocol, but they may communicate according to other protocols if they can communicate using a common bus line.

In the first embodiment, the address memory 114A employs non-volatile memory, but it may employ RAM. In this case, because the stored address is erased when the air conditioning system 1 stops and power supply is interrupted, the address must be re-assigned every time of the air conditioning system 1 is booted. Alternatively, the power (Vcc, GND) must be always supplied, even the air conditioning system 1 stops, so that the information in the address memory 114A does not vanish.

In the first embodiment, an address is assigned to each door servo actuator 110,120,130 with a bus system based on the LIN protocol, but the address can be assigned with other bus systems that use a single line. In this case, the following procedure is applicable. The master ECU 200 sequentially issues a query for each counter value. Then, it waits for a reply from the door servo actuator 110,120,130 that has stored the counter value that is the subject of the query. Then, the master ECU 200 instructs the door servo actuator 110,120,130 that replies to set its address to a predetermined address that corresponds to the counter value.

Such changes and modifications are to be understood as being within the scope of the present invention as defined by the appended claims.

What is claimed is:

1. A communication system, comprising:
a plurality of slave units associated with a unique quantity, wherein each has a unique quantity;
a master unit communicating with the slave units;
a network line connected to the plurality of slave units and to the master unit, wherein:
the master unit issues a query to the slave units, wherein the query seeks to determine whether a predetermined value corresponds with the unique quantity of any of the slave units; and
each slave unit sets a unique address based on an instruction of the master unit when the predetermined value of the query corresponds to the unique quantity associated with each slave unit.

2. The communication system according to claim 1, wherein the network line is formed in the shape of a loop.

3. The communication system according to claim 1, wherein:
the slave units respectively control a plurality of door servo actuators for adjusting an open degree of several kinds of doors in a vehicle air conditioning system; and
the unique quantity is a maximum operation degree of each door servo actuator.

4. The communication system according to claim 1, wherein:
the slave units respectively control a plurality of door servo actuators for adjusting an open degree of several kinds of doors in a vehicle air conditioning system; and
the unique quantity is a current value of the supplied driving current when each door servo actuator is operated.

5. The communication system according to claim 3, wherein:
the master unit transmits an operation instruction for all of the plurality of slave units to operate the door servo actuators from the base position to the maximum operation degree position before the query is issued; and
each slave unit determines the maximum operation degree by operating the door servo actuator controlled by the slave unit, when each slave unit receives an instruction from the master unit.

6. The communication system according to claim 1, wherein each slave unit includes a unique quantity memory to store the unique quantity.

7. The communication system according to claim 1, wherein the slave unit comprises an address memory to store the set address.

8. The communication system according to claim 1, wherein the network communication in the system takes place only on the network line, which is a single line.

9. A method for assigning an address, comprising:
issuing a query to a plurality of slave units, wherein the query seeks one slave unit that is associated with one of a plurality of predetermined unique quantities and each slave unit has a unique quantity; and
setting an address in the one slave unit based on an instruction of the master unit when a value that is the subject of the query corresponds to the unique quantity associated with the one slave unit, whereby the master unit assigns an unique address to the one slave unit that has a unique quantity corresponding to the value.

10. The method according to claim 9, wherein the slave units respectively control a plurality of door servo actuators for adjusting an open degree of several kinds of doors of a vehicle air conditioning system;
the unique quantity is a maximum operation degree of each door servo actuator;
the method further comprising:
transmitting an operation instruction from the master unit for all of the slave units to operate the door servo actuators from a base position to a maximum operation degree position before the query is issued; and, determining the maximum operation degree in each slave unit by operating the door servo actuator controlled by the slave unit, when the slave unit receives an operation instruction from the master unit.

11. A method of setting unique network addresses in a network that includes a master controller and a plurality of slave units, wherein the master controller communicates to each slave unit through network communication and each slave unit has a unique quantity, the method comprising:
determining in each slave unit the unique quantity by performing an operation and measuring a result of the operation;
storing in each slave unit the unique quantity;
assigning a unique network address to each slave unit in correspondence with the unique quantity stored in each slave unit.

12. The method of claim 11, wherein the slave units are connected to a network line that leads to the master controler.

13. The method of claim 11 including storing the network address in non-volatile memory in each slave unit.

14. The method of claim 11 wherein the slave units are servo-motor actuators and the operation is an operation of the servo-motor in a predetermined routine.

15. The method of claim 11 including installing the network in a vehicle such that each slave unit serves to actuate a different door in a vehicle air-conditioning system.

16. The method of claim 11, wherein the method includes storing data in the master controller that represents a correspondence between a plurality of unique quantities and unique network addresses.
